(19) United States
(12) Patent Application Publication
(10) Pub. No.: US 2021/0071902 A1
(43) Pub. Date: Mar. 11, 2021

(54) MODULAR SYSTEM FOR AN AIR OUTLET ASSEMBLY

(71) Applicant: DR. SCHNEIDER KUNSTSTOFFWERKE GMBH, Kronach (DE)

(72) Inventor: Tobias MOECKEL, Burgkunstadt (DE)

(21) Appl. No.: 16/978,649

(22) PCT Filed: Apr. 5, 2019
(86) PCT No.: PCT/EP2019/058684

§ 371 Date: Sep. 4, 2020

(30) Foreign Application Priority Data
Apr. 11, 2018 (DE) 10 2018 108 645.8
Jan. 16, 2019 (DE) 10 2019 101 038.1

(51) Int. Cl. F24F 13/15; B60H 1/00; B60H 1/34

(52) U.S. Cl. CPC F24F 13/15; B60H 2001/3471; B60H 1/3421; B60H 1/00542

(57) ABSTRACT

Disclosed is a modular system for an air outlet assembly, having at least one first module and a second module, wherein the modules function for air guiding, air deflection, air flow control, air supply and/or discharge, air treatment and/or for presentation. The modules have respective first securing elements which permit a securing of the at least two modules, wherein the at least two modules can be connected to one another via the first securing elements in any order and number. In this way, air outlets can be adapted to different requirements without respective separate air outlets having to be designed and produced.

A modular system for an air vent arrangement is described. The air vent arrangement comprises at least one air vent with a housing and at least one air guide element.

### BACKGROUND

Air vents serve for deflection of output air made available by an air-conditioning unit or other ventilating equipment. Air vents are used in vehicles in order to introduce fresh air, temperature-controlled air and/or conditioned air into the passenger compartment of a vehicle. Vehicles can be, for example, motor vehicles such as cars, trucks or buses, trains, aircraft or ships. In the case of air vents, apart from control of deflection of output air from, for example, an air-conditioning unit, it is usually also possible to regulate the amount of output air. The amount of supplied air can be regulated by way of a control device which, for example, is arranged together with a control device for pivotation of slats or separately from such a control device near an outflow opening. The amount of supplied air can be regulated by way of, for example, throttle devices with throttle flaps. Air vents can be arranged in a vehicle dashboard or in the region of the A, B or C pillar or at the roof of a motor vehicle.

### PRIOR ART

Conventional air vents are configured in such a way that they are designed for a specific purpose of use, for example for a specific vehicle type. In addition, air vents within a vehicle, for example along a motor vehicle dashboard, can have different designs, in which case the air vents differ with respect to the shape and design of the housing, the number of air guide elements and the design of throttle devices and screens arranged at the front.

It is therefore necessary to conceive a separate air vent for each individual vehicle type and, moreover, for each position. Substantial costs arise as a result, since the air vents can be made in smaller batches and a separate air vent has to be conceived and produced for each case of use.

The additional outlay then arising leads to high costs and an enormously high expenditure of time. In addition, checking of the outflow performance has to be carried out for each air vent.

### Object

There is accordingly a need for a solution which eliminates the disadvantages of the prior art. In addition, a solution offering universal usability and construction of air vents shall be offered.

### Solution

The afore-mentioned object is fulfilled by a modular system for an air vent arrangement, comprising at least one first module and second module, wherein the modules serve for air guidance, for air deflection, for air quantity regulation, for air quantity division, for air quantity combining, for air feed and/or discharge, for air treatment and/or for presentation, and wherein the modules each have first fastening elements which enable fastening of the at least two modules, wherein the at least two modules are connectible together in a desired sequence and number by way of the first fastening elements.

The modular system makes it possible to provide air vents which draw on a number of produced modules, wherein the modules are selected in correspondence with requirements and are connectible together in a desired sequence. It is thus also possible, for example, to arrange two identical modules one behind the other. Moreover, it is possible by way of the first fastening elements to connect the modules not only one behind the other as desired, but also to rotate the modules through, for example, 180° and/or to connect them with an adjacent module. The rotation can be carried out about the longitudinal or transverse axis of the modules.

For that purpose, a special design of the first fastening elements is essential. These enable a freely selectable arrangement of the modules together.

The modules themselves can be of different design and in that case have elements and shapes appropriate to different functions. It is significant that the modules have contact regions which enable connection of the modules. The contact regions are formed in such a way that the modules bear against one another at the contact regions and are connected together by way of the first fastening elements. The contact regions can be constructed to be sealing, so that escape of air conducted through the modules cannot take place by way of the contact regions.

The modules are therefore substantially of such a construction in their design that they have similar or identical cross-sections, so that they are connectible together and seal relative to the environment. The modular system can in addition comprises modules which have larger cross-sections so that different air vent arrangements with different cross-sections can be provided. In that case, modules can be provided which produce a cross-sectional decrease or increase. The decrease or increase can also be established by the arrangement of the connecting modules. In addition, further modules can be provided which enable apportioning of an air flow, starting from one module or air channel, to two, three or more modules. Such connecting modules can then also be constructed as diverters in order to control the air flow to the respective modules mounted thereafter.

In addition, an air channel of the air vent arrangement can in that case be formed from different modules which are connectible together as desired. Different kinds of air vent arrangements can therefore be provided from a relatively small number of modules, in which case there is resort to predefined parts.

The modules can comprise a housing at which the first fastening elements are arranged, wherein the housings of the modules are connectible together by way of the first fastening elements. Moreover, the housings have contact points (contact regions) by way of which the housings bear against one another in the connected state. These contact regions can comprise encircling seals. The seals can be applied to housings and modules of plastics material in a two-component injection-moulding method. In alternative constructions, sealing elements of foam, a thermoplastic elastomer (TPE) or, for example, silicone can be applied subsequently. The connection can be effected by way of, for example, gluing.

At least one housing can consist of at least two housing parts which are connectible together by way of second fastening elements. This makes it possible to design the individual housings to be different in correspondence with the requirements. In that case, the housing parts can differ with respect to the length relative to a flow path of the air, the cross-section of the air channel formed by way of the housing halves, and the further fastening elements for mounting additional components.

The housings and the modules themselves can consist predominantly of plastics material and are therefore economically and quickly producible in an injection-moulding process, inter alia in a multi-component injection-moulding process.

At least one housing can comprise two pairs of opposite side walls, wherein the side walls are connectible together by way of second fastening elements. The production of the modules is in that case further simplified, since the housings are formed from side walls which are then designed to be substantially plate-shaped. To that extent, this has a positive influence on production of the side walls, since no slides or other devices are required in the injection-moulding tools. Moreover, several side walls can then be produced more quickly. The joining together of the side walls takes place by way of the second fastening elements, analogously to the two housing parts, in which case a modular housing is produced. The side walls as well as the housing parts can have bearing mounts for, for example, air guide elements or throttle flaps. In addition, structures, holding devices or other shapings or passages can be provided, by way of which further components are guided into or out of the housing or mounted.

The housing can have third fastening elements by way of which controlling, regulating, lighting and/or coupling devices are attachable. The third fastening elements can be provided not only on the inner side, but also on the outer side of the housing. For preference, the housings are constructed in such a way that, for example, control devices of different kinds, for example manually controlled or motor-controlled, can be provided alternatively and also together. The housings are therefore constructed from ground up so that regardless of whether manual or electrical control is provided the shapings required for the mounting are already provided. It is therefore not necessary to undertake any adaptation of the housings to different concepts or embodiments of air vent arrangements.

In further forms of embodiment, two housings are directly connectible together by way of the third fastening elements or by way of a connecting module having corresponding fourth fastening elements. In that case, several third fastening elements can be provided so that not only mounting of controlling, regulating, lighting and/or coupling devices is possible, but also connection of two housings together. The connecting module can be constructed in such a way that a parallel arrangement of modules is possible. The modules can also be constructed in such a way that an angular arrangement in a desired orientation relative to one another is possible. In addition, the connecting modules can have flexible sections so that the arrangement of the modules connected together by way of the connecting module is variable. For that purpose additional locking devices can be provided.

The modules can be connectible by way of the first fastening elements with an air channel and/or a ventilating device, wherein the corresponding connecting points (contact regions) have corresponding first fastening elements. The ventilating device can be, for example, an air-conditioning unit, which is connectible with the air vent arrangement, having an air channel of modules. In addition, seals are provided at the contact points, in which case the housings have, for that purpose, contact sections so that there is no escape of air.

The modules can comprise at least one air guide module, lighting module, ventilating module, cleaning module, screen module, throttle module and/or filter module. An air guide module can have at least one first group of slats, which are mounted about a defined pivot axis in the housing. A lighting module can comprise lighting devices such as light-emitting diodes, optical conductors and illuminatable components. Lighting of the air vent arrangement can take place by way of that. In further forms of embodiment the housing of the lighting module can itself be illuminatable so that a corresponding section is illuminated and this section leads to lighting of the air channel and thus the air vent arrangement. A scenting module can comprise nozzles by way of which scenting substances can be added to the throughflowing air flow. A cleaning module can comprise filter devices which filter out solids such as, for example, dust. A screen module is, in classic manner, mounted as a closure element on a module and forms the visible part of the air vent arrangement, for example in a vehicle dashboard of a motor vehicle. The screen module itself can in that case also comprise stationary or pivotable air guide elements. The screen module can, in particular, be constructed in such a way that this has first fastening elements only on one side of the housing, so that the opposite side is free of fastening elements. This makes it possible to mount the screen module with only slight variability on the modules, but it is possible to place the screen module on the different modules as desired. In addition, in order to achieve different designs for the air vent arrangement an exchange of the screen module can be carried out. Depending on the desired design, a corresponding screen module is then selected and placed on the air vent arrangement so that all requirements and optical desires are taken into account by means of the modular system. In further forms of embodiment closure elements can be placeable on fastening elements of screen modules so as to cover these. A throttle module can comprise, for example, a throttle flap which is pivotably mounted so as to regulate the air flow quantity. A filter module can comprise filters and other devices which serve not only for mechanical, but also for chemical cleaning of air. In addition, mention can be made of photocatalytic cleaning surfaces, in which the surfaces are irradiated by way of an infrared diode so as to achieve cleaning of the throughflowing air. In that case, in particular, volatile organic compounds (VOC) can be eliminated from the issuing air flow.

The modules can comprise at least one air guide element and/or at least one throttle flap. Air guide elements can be, for example, slats. The arrangement of the modules relative to one another then makes it possible to, for example, arrange so-called H slats in front of or behind so-called V slats. It is possible to arrange therebetween, for example, further modules such as a lighting module, a cleaning module or a filter module. The sequence of the individual modules relative to one another as well as the orientation thereof can be adapted as desired.

The modules can in that case be selectable from at least two different modules, wherein the different modules differ with respect to the length, width, thickness, material, number of bearing openings for air guide elements, throttle flaps, number, construction and design of air guide and/or throttle elements, filter devices, lighting devices, scenting devices and/or the external shape, etc.

The fastening elements can comprise detent elements, pins, hooks, insertion openings as well as general connecting means, which are so arranged and constructed that a desired arrangement of the individual modules in a desired sequence and desired orientation can be possible.

The modular mode of construction according to the modular principle makes it possible to use the same air vent arrangements for different vehicle types and kinds, in which case costs can be reduced by the modular mode of construction. The use of the modules for construction of air vent arrangements for a multiplicity of vehicles obviously offers a number of advantages, for example with respect to supply, production, maintenance, tooling, costs, environment, etc.

Moreover, several air vent arrangements can be arranged not only adjacent to one another, but also one above the other. In addition, a combination is possible whereby different outflow arrangements can be realised with several air vent arrangements.

In further forms of embodiment, air guide elements of individual modules can be connected directly or by way of couplings with air guide elements of adjacent air vent arrangements, wherein the air vent arrangements are arranged one above the other or adjacent to one another, so that pivotation of all or several air guide elements or throttle flaps can be effected by way of a single control or activation device.

Drive devices which can be coupled with air guide elements, throttle devices, etc., can be mounted on the modules. A drive device can comprise an electronic, electrical, electromechanical, hydraulic, pneumatic or mechanical drive. In addition, electric motors, control wheels, control elements, etc., can be provided.

In order to couple pivotable elements such as, for example, throttle flaps and air guide elements of adjacent air vent arrangements a connecting shaft can be provided which is of flexible construction so that a desired orientation of the two air vent arrangements relative to one another can be realised and a further standard component can be drawn upon as a module.

Further advantages, features and possibilities of design are evident from the following figure description of embodiments, which are to be understood as non-limiting.

### BRIEF DESCRIPTION OF THE DRAWINGS

In the drawings:

FIG. 1 shows a schematic illustration of an air vent arrangement;

FIG. 2 shows a schematic illustration of a further air vent arrangement;

FIG. 3 shows a schematic exploded drawing of a housing consisting of four side walls;

FIG. 4 shows a schematic illustration of yet a further air vent arrangement;

FIG. 5 shows a schematic illustration of two modules with fastening elements; and

FIG. 6 shows yet a further schematic illustration of two modules with fastening elements.

In the drawings, elements provided with the same reference numerals substantially correspond with one another insofar as nothing to the contrary is indicated. Moreover, illustration and description of components which are not significant to understanding the technical teaching disclosed herein are dispensed with. Further, the reference numerals are not repeated for all already introduced and illustrated elements insofar as the elements themselves and the function thereof have been already described or are known to an expert.

### Explanatory Description of Embodiments

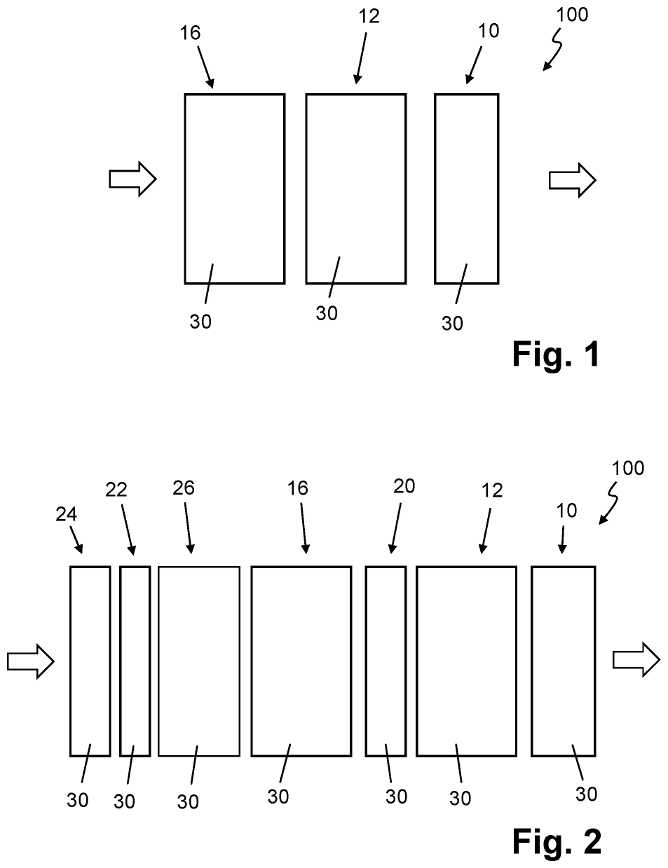

FIGS. 1 to 6 show different embodiments of air vent arrangements 100 as well as components and forms of embodiment of the respective arrangements. Such an air vent arrangement 100 can be used in, for example, a vehicle and be connected with an air-conditioning unit or another ventilating device. The air vent arrangements can for that purpose be provided in a vehicle dashboard in the region of the A, B or C pillar as well as in the region of the rear seat row. The air-conditioning unit or the other ventilating device is connected with such air vent arrangements 100 by way of air channels. In that case the air channels can also be part of the air vent arrangements 100.

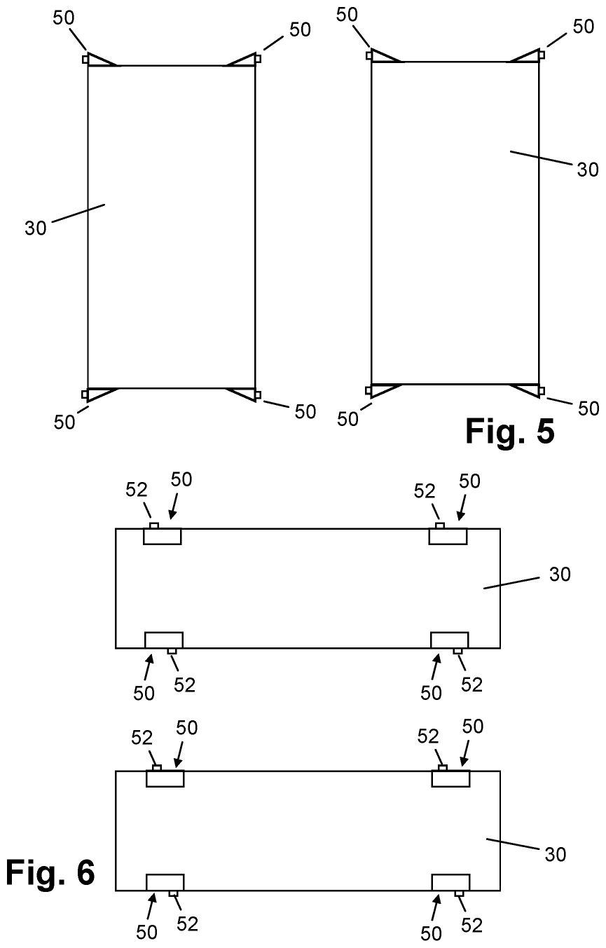

FIG. 1 shows a schematic illustration of an air vent arrangement 100 consisting of three individual modules. The air vent arrangement 100 comprises a screen module 10, a first air guide module 12 and a second air guide module 16. The modules comprise housings 30, which have fastening elements 50, as shown in FIGS. 5 and 6. The housings 30 consist of plastics material and are produced in an injection-moulding process, in which case production is simple. Slats 14 and 18 are received in the housings 30 of the first air guide module 12 and the second air guide module 16. These slats 14, 18 are mounted in the modules to be pivotable about their longitudinal axes. The slats 14 of the first air guide module 12 are mounted in the housing 30 about a pivot axis extending orthogonally to the slats 18 of the second air guide element 16. The screen module 10 in the illustrated form of embodiment does not have pivotably mounted air guide elements. However, the screen module 10 can have transversely extending webs, roller-shaped bodies, grilles or other devices, which are provided in the region of an air outlet opening. The flow direction of the throughflowing air is schematically indicated by way of the arrows.

An air guide module can have fastening elements at each housing side so that in the case of a substantially square cross-section a rotation of the module through 90° provides an H slat module instead of a V slat module, and conversely.

The air vent arrangement 100 of FIG. 1 provides an air vent which produces air deflection in different directions. A coupled air deflection can also be achieved by way of common pivotation of the slats 14 and 18. The housing 30 has coupling regions (contact regions) which in the connected state of the air vent arrangement 100 bear against an identically formed contact region of the other module. The modules are so connected together by way of the fastening elements 50 that no leakage air flow can escape or air enter by way of the encircling contact points.

In order to produce the air vent arrangement 100 the modules are selected from a number of individual modules and are arranged relative to one another in the required sequence, number and orientation. By virtue of the modular construction with the bearing and contact regions as well as the fastening elements 50 it is, for example, possible to arrange the first air guide module 12 to be upstream of the second air guide module 16 in air flow direction. In this case, for example, the second air guide module 16 can also be directly connected with the screen module 10. The modules are selected from a reserve of different modules, wherein in addition different first air guide modules 12 and second air guide modules 16 can be provided. The screen modules can also differ, so that an appropriate screen module 10 is selected with respect to the desired visual design. If a screen module 10 additionally has pivotably mounted air guide elements then it can be possible, for example, to dispense with a first air guide module 12 or a second air guide module 16 or both.

Since at least the air guide modules 12 and 16 can have first fastening elements 50 on both sides, then, for example in the embodiment of FIG. 1, a coupling module 24 (as shown in FIG. 2), which is connected with an air channel, can be coupled to the lefthand side of the second air guide module 16. The air channel itself can comprise individual modules having first fastening elements which are provided at a housing with an encircling connection. As a result, air channels can be formed by variously constructed air channel modules which can be connected together in any arrangement and sequence in correspondence with the module concept and the principle of modularity.

In addition, modules with larger cross-sections or smaller cross-sections can be provided. Such modules can be incorporated in air vent arrangements 100 by appropriate connecting modules, wherein the connecting modules have a contact section with a smaller diameter and a contact section with a larger diameter. Air vent arrangements 100 having larger or smaller cross-sections than other air vent arrangements 100 can also be formed, in which case all modules have the appropriate larger or smaller cross-section.

FIG. 2 shows a schematic illustration of a further air vent arrangement 100. The air vent arrangement 100 comprises a screen module 10, a first air guide module 12 fastened thereto, a lighting module 20 fastened thereto, and a second air guide module 16 fastened thereto, wherein a throttle module 26, a filter module 22 and finally a coupling module 24 are mounted on the second air guide module 16. The throttle module 26 comprises a throttle flap which is provided for air quantity regulation. The filter module 22 filters the throughflowing air and for that purpose can comprise, for example, photocatalytic cleaning surfaces, which are activatable by way of an infrared diode. The lighting module 20 comprises lighting elements which introduce light into the air channel, which is formed by the individual modules, so that the air vent displays light over the screen module 10.

In the embodiments in FIGS. 1 and 2 the sequence of the individual modules can be varied. In addition, further modules can be added or removed without special precautions having to be undertaken in that regard. In addition, it is possible to rotate individual modules, for example, in their orientation through 180 degrees so that, for example, a lower lighting track can then also be arranged by way of that in the upper section, and conversely.

The cross-section of the individual modules can be rectangular, square, round, elliptical or otherwise. In particular, substantially rectangular or square cross-sections can have chamfers or radiusings in the corner regions.

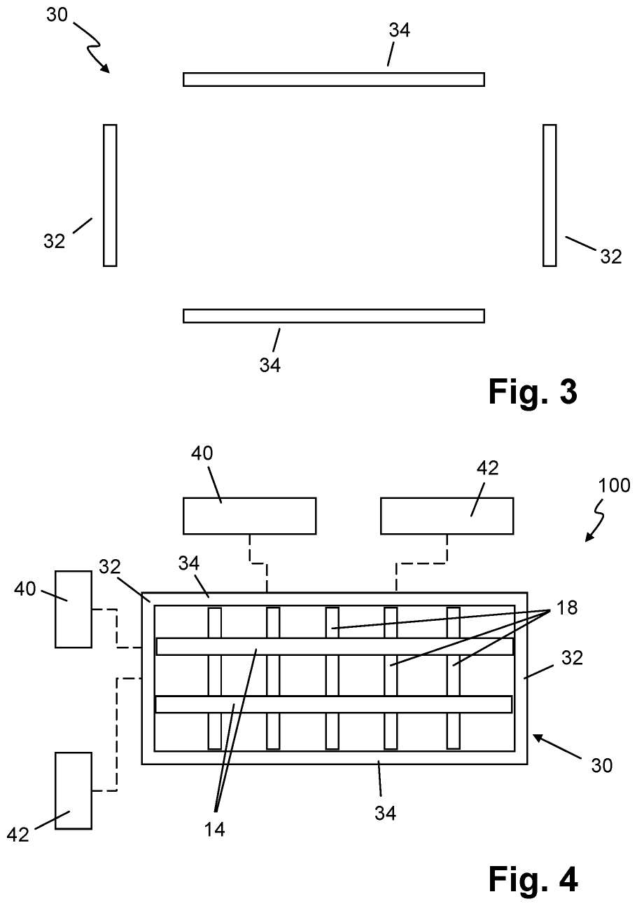

FIG. 3 shows a schematic exploded drawing of a housing 30, which consists of four side walls 32, 34, of a module. Production of the module takes place by way of joining together two pairs of side walls 32 and 34, which for that purpose have second fastening elements.

The side walls 32 and 34 are connected together by way of the second fastening elements. The side walls 32 and 34 can be exchanged depending on the correspondingly desired shape and cross-section. Thus, for example, longer side walls 34 can be exchanged for shorter or longer side walls 34 so as to produce a corresponding housing 30. In addition, the side walls 32 can be replaced by correspondingly larger or shorter side walls 32. In addition, the depth of the side walls 32, 34 can be varied by appropriate selection of the side walls 32, 34. The side walls 32, 34 can have bearing openings for the slats 14, 18 or other devices. In addition, shaped portions and holding elements can be provided, which serve for filter devices, lighting devices or throttle flaps, etc. Provided at the outer side are third fastening elements which on the one hand serve the purpose of mounting different control units and, beyond that, connecting two housings 30 not only by way of the fastening elements 50 one behind the other, but adjacent to one another so that two air vent arrangements 100 extending adjacent to one another or at an angle thereto can be produced.

The production of housings 30 of different size can serve the purpose, for example, of providing an air guide module 16 having, for example, five slats 18. If further slats 18 are needed, then longer side walls 34 having an appropriate number of bearing openings have to be provided. The correspondingly desired shape can therefore be taken into account by selection of the side walls 34. If further modules, which are to be mounted in front of or behind that, have a smaller width than the thus-formed second air guide module 16 then use can be made of connecting modules which increase or decrease the cross-section and are connected by way of first connecting elements 50.

FIG. 4 shows a schematic illustration of a further air vent arrangement 100. This comprises at least one first air guide module 12 and second air guide module 16 with slats 14 and 18. As schematically indicated, actuators 40 with electric motors or control wheels 42 can be mounted on the side walls. For that purpose corresponding third fastening elements are provided at the side walls 32 and 34. These fastening elements are present on either side of the housing 30 at the side walls 32 and 34 so that the actuators 40 and control wheels 42 can be arranged on the lefthand side, on the righthand side and above or below. It is also possible, for example, to provide one unit on the lower side and the other at the upper side or both units at one side.

FIG. 5 shows a schematic illustration of two modules with fastening elements 50. FIG. 5 shows two housings 30 of modules which have corresponding fastening elements 50. The fastening elements 50 comprise hooks 52 (see FIG. 6) which engage in corresponding receptacles of a corresponding fastening element 50. The depicted design of the fastening elements 50 is illustrative in nature and therefore does not restrict the different variants. Fastening elements can therefore also be constructed differently as long as an arrangement of the modules and fastening in desired sequence and desired orientation relative to one another is possible. In addition, further first fastening elements 50 can be provided laterally.

FIG. 6 shows yet a further schematic illustration of two modules with fastening elements 50, in which case it is shown how an arrangement in desired sequence can be achieved by appropriate design of the fastening elements. Further modules can, for example, be inserted between the two housings 30. In addition, the sequence of the housings 30 or modules can be changed without giving rise to difficulties at the time of mounting.

### REFERENCE NUMERAL LIST

10 screen module
12 first air guide module
14 slat
16 second air guide module
18 slat
20 lighting module
22 filter module
24 coupling module
26 throttle module
30 housing
32 side wall
34 side wall
40 actuator
42 control wheel
50 fastening element
52 hook
100 air vent arrangement

1. Modular A modular system for an air vent arrangement for vehicles, comprising at least one first module and second module, wherein the modules serve for air guidance, for air deflection, for air quantity regulation, for air feed and/or discharge, for air treatment and/or for presentation, and wherein the modules each have first fastening elements which are configured to enable fastening of the at least two modules, wherein the at least two modules are connectible together one behind the other in a desired sequence and number by way of the first fastening elements.

2. The modular system according to claim 1, wherein the modules comprise a housing at which the first fastening elements are arranged, wherein the housings of the modules are configured to be connectible together by way of the first fastening elements.

3. The modular system according to claim 2, wherein at least one housing consists of at least two housing parts, which are configured to be connectible together by way of second fastening elements.

4. The modular system according to claim 2, wherein at least one housing comprises two pairs of opposite side walls and the side walls are configured to be connectible together by way of second fastening elements.

5. The modular system according to claim 2, wherein the housings comprise third fastening elements by way of which controlling, regulating, lighting and/or coupling devices are attachable.

6. The modular system according to claim 5, wherein two housings are configured to be directly connectible together by way of the third fastening elements or by way of a connecting module having corresponding fourth fastening elements.

7. The modular system according to claim 1, wherein the modules are configured to be connectible by way of the first fastening elements with an air channel and/or a ventilating device, wherein the corresponding coupling points have corresponding first fastening elements.

8. The modular system according to claim 1, wherein the modules comprise at least one air guide module, lighting module, scenting module, cleaning module, screen module, throttle module and/or filter module.

9. The modular system according to claim 1, wherein the modules comprise at least one air guide element and/or at least one throttle flap.

10. The modular system according to claim 1, wherein the modules are selectable from at least two different modules and the different modules differ with respect to length, width, thickness, material, number of bearing openings for air guide elements, throttle flaps, number, construction and form of air guide and/or throttle elements, filter devices, lighting devices, scenting devices and/or external shape.

11. The modular system according to claim 3, wherein at least one housing comprises two pairs of opposite side walls and the side walls are configured to be configured to be connectible together by way of second fastening elements.

12. The modular system according to claim 3, wherein the housings comprise third fastening elements by way of which controlling, regulating, lighting and/or coupling devices are attachable.

13. The modular system according to claim 12, wherein two housings are configured to be directly connectible together by way of the third fastening elements or by way of a connecting module having corresponding fourth fastening elements.

14. The modular system according to claim 4, wherein the housings comprise third fastening elements by way of which controlling, regulating, lighting and/or coupling devices are attachable.

15. The modular system according to claim 14, wherein two housings are configured to be directly connectible together by way of the third fastening elements or by way of a connecting module having corresponding fourth fastening elements.

16. The modular system according to claim 2, wherein the modules are configured to be connectible by way of the first fastening elements with an air channel and/or a ventilating device, wherein the corresponding coupling points have corresponding first fastening elements.

17. The modular system according to claim 2, wherein the modules comprise at least one air guide module, lighting module, scenting module, cleaning module, screen module, throttle module and/or filter module.

18. The modular system according to claim 2, wherein the modules comprise at least one air guide element and/or at least one throttle flap.

19. The modular system according to claim 2, wherein the modules are selectable from at least two different modules and the different modules differ with respect to length, width, thickness, material, number of bearing openings for air guide elements, throttle flaps, number, construction and form of air guide and/or throttle elements, filter devices, lighting devices, scenting devices and/or external shape.

20. The modular system according to claim 3, wherein the modules are configured to be connectible by way of the first fastening elements with an air channel and/or a ventilating device, wherein the corresponding coupling points have corresponding first fastening elements.
